(19) United States
(12) Patent Application Publication
(10) Pub. No.: US 2011/0289496 A1
(43) Pub. Date: Nov. 24, 2011

(54) METHOD & APPARATUS FOR LOAD BALANCING SOFTWARE UPDATE ACROSS A PLURALITY OF PUBLISH/SUBSCRIBE CAPABLE CLIENT DEVICES

(75) Inventor: JONATHAN P. STEER, Nashua, NH (US)

(73) Assignee: North End Technologies, Inc., Nashua, NH (US)

(21) Appl. No.: 12/782,587

(22) Filed: May 18, 2010

(51) Int. Cl. G06F 9/44

(52) U.S. Cl. 717/169

(57) ABSTRACT

A plurality of client communication devices, such as robotic devices, are in communication over a network with a software update service that periodically provides update software files to the client devices. The client devices register with the update service and are assigned a database queue in which an update software file is stored for the client device. Periodically, and according to a selected set of rules, the update service notifies the client devices that they can retrieve update software from a database maintained by the update service. In response to notification of the availability of a software update by the service, the client devices can send a request to the database to download the latest version of a software file.

### FIELD OF INVENTION

The invention relates to the general area of server load balancing and specifically to balancing a servers load with respect to the broadcasting of update software files to a large population of client devices that are compatible with a publish/subscribe communications network model.

### BACKGROUND

Computing and/or communication devices typically include a number of software or firmware application or operating files that they employ to perform certain functionality during operation. From time to time these files become obsolete or need to be updated for various reasons. While it is possible to purchase new revisions of a software package on a physical medium, such as a disk, it is often more convenient to purchase and receive the updated software electronically over a wide area communications network such as the Internet. Typically, the process of updating software in client devices is managed by a server that is located in the network remote from the client devices. This server has access to a store of update software that it can transmit to the clients upon request. In addition to managing the software update process, the server may also support communication sessions (electronic, audio and/or video) and other requests for information stored in a database accessible by the server.

Updating software for a large population of client devices connected to a network becomes problematical during times of peak network demand. At such times, servers on the network can become over loaded and unable to process low priority client requests, such as requests for updating client software. During peak traffic times, the software update process can be delayed or client devices may be denied requests for software updates. One solution to the server overloading problem is to distribute the available services (communications, requests for information, updating software, etc.) among two or more servers. An arrangement in which multiple servers all perform similar functionality is typically referred to as a server farm and the server farm can be seen by the clients as a single logical server over the network. In order to balance load among multiple servers, load balancing functionality can be included in a network device (gateway or router) that intercepts requests from client devices and directs these requests to one of the multiple servers in the server farm based upon some set of rules, such as the priority of the request or which/what type of client is making the request. One example of a server load balancing service is the “UltraMonkey” project and another example is the “Apache web server's mod proxy-balancer extension”.

Server load balancing can be designed to operate in a network environment in which clients are “pulling” information from the servers or the servers are pushing information to the clients. Pull technology refers to a network transaction between a client and a server in which the client device sends a message to the server that includes a request for information. Pull technology simply refers to the network device which requests for network information are initiated, which in the case of pull technology is the client device. Pull technology is commonly used in web browsers as a means to initiate the gathering of information about any particular subject of interest and generally is employed in clients where the information of interest is not known in advance. Pull technology is also used to update software located on client devices such as anti-viral software. On the other hand, push technology refers to a network transaction between a server and a client in which the server initiates the transaction. Typically, the server has some information, such as update software information (anti-viral update) that can be transferred to the client when the client is turned on and connected to the network. At the point that the client device is turned on and connected to the network, an agent on the client can send the server a message that includes an indication that the client is “on-line” and which includes information that uniquely identifies the device. At this point the server can initiate the transfer of information to the client device. Such a “push” method for updating client software is described in U.S. Pat. No. 7,013,330 assigned to Network Associates. The load balancing methodology described in this patent reacts to high load situations by distributing, on-the-fly, the down loading operation among a fixed number of servers. Such a reactive load balancing methodology can work well as long as the down loading operations can be distributed among the servers without any one or more of the servers becoming overloaded. In other words, the number of requests for new software from client devices may surpass the ability of all of the servers working together to deliver the updated software files. In this event, one or more of the servers may send a denial of service message to the clients and the process stalls.

U.S. patent application Ser. No. 12/142,219 entitled “Load Balance Server and Method for Balancing Load of Presence Information” assigned to KDDI R&D Laboratories, Inc. describes a load balancing method employed in an instant messaging environment. While the load balancing method described in the Ser. No. 12/142,219 application does mitigate the problem associated with one server handling presence information from an over whelming number of clients at the same time, the load balancing functionality is only invoked at the point that any single server becomes overloaded. In other words, the load balancing functionality described in the Ser. No. 12/142,219 application is reactive in nature. While such a reactive approach to balancing traffic over a number of servers works well as long as there are an adequate number of servers available over which to distribute the traffic/load, such an arrangement breaks down when the volume of traffic is such that all of the servers become over loaded.

Therefore, a need exists to provide a method that overcomes the limitations of the prior art server load balancing arrangements which are based upon reactive, pull based technologies.

### SUMMARY

These and other limitations of the prior art are resolved in a method for updating client side software in a publish/subscribe capable communication device wherein the communication device sends a message to an update manager requesting to subscribe to an software update service and the update manager assigns the requesting communication device to a software update subscription queue, the update manager then sends a message to the communications device indicating that a software update is available after which the communications device can request the software update for a file server which retrieves the software update file and transmits it to the communications device.

### BRIEF DESCRIPTION OF THE FIGURES

FIG. 1 is a network level diagram showing a plurality of publish/subscribe capable client devices, a logical server running XMPP and a dbase associated with the logical server.

FIG. 2 is a block diagram of a gateway and the logical XMPP server of FIG. 1 as multiple server devices in association with a dbase.

FIG. 3 is a functional block diagram of a publish/subscribe capable client device of FIG. 1.

FIG. 4 is a functional block diagram of the XMPP server of FIG. 1.

FIG. 5 is a diagram illustrating a signaling protocol used to implement the invention.

### DETAILED DESCRIPTION

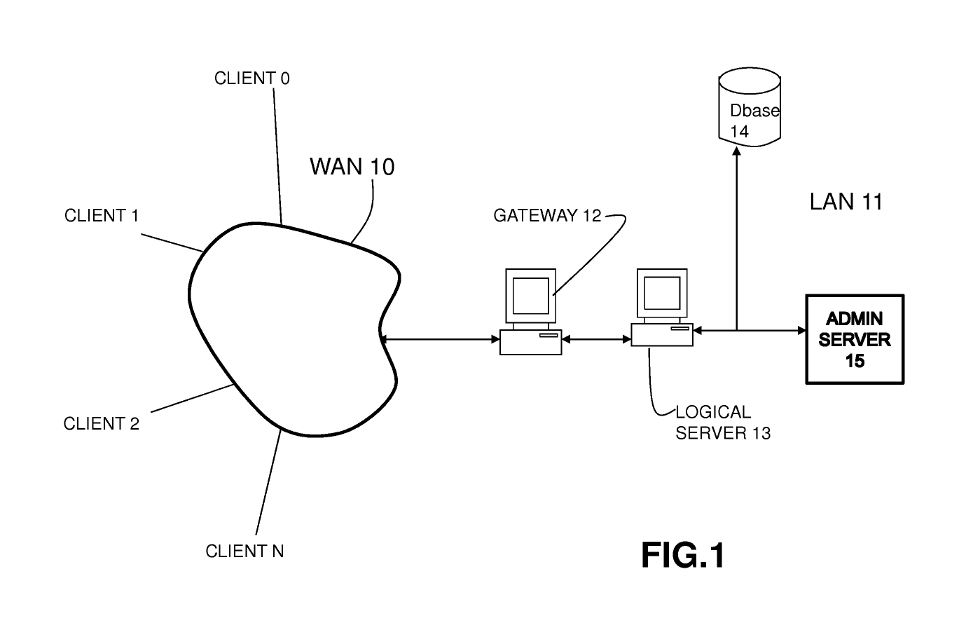

FIG. 1 generally illustrates a network designed to support communication between any two or more publish/subscribe (pub/sub) capable client devices. In general, the network architecture illustrated in FIG. 1 is able to support file transfers, text, instant messaging (IM), voice and/or video communication sessions. Client communication devices attached to a network, such as the network illustrated in FIG. 1, typically include application and operating software or firmware that need to be updated from time to time. It is typically convenient for those individuals using the client devices to receive software updates and for the organizations which provide the support services to distribute the software updates electronically over the network.

Many client communication devices, such as laptops and PCs, are turned off at night and then turned back on in the morning. Typically, in any one geographic area, the majority of these devices are turned on during a relatively narrow window of time in the morning which has the effect of creating a spike of network activity during this time. If update software is available during the peak morning period, the server that is managing the software update process can quickly become over whelmed which has a denigrating effect on the quality of service provided to the client devices. Server load balancing technology can be employed in such cases to “smooth” or distribute the updating of software to a large number of client devices over multiple servers in a network.

More specifically, FIG. 1 shows a wide area network (WAN) 10 and a local area network (LAN) 11 that can be interconnected via a suitable hi-speed line 15. A plurality of client communication devices 0, 1, 2, and N and a gateway 12 are all connected to the WAN 10. A logical server 13 is in communication with the gateway 12, a data base 14 and an administrative server 16. The WAN 10 can be any public network such as the Internet or a private enterprise network such as one maintained by a large organization. The LAN 11 can be any local network in which the component parts communicate with each other according to the well know Ethernet standard or some other standard or proprietary communications protocol. Each of the client communication devices 0, 1, 2 and N can be any type of communication device that can be connected to the WAN 10 for the purpose of communicating with any of the other client communication devices 0, 1, 2 and/or N. These devices can be a fixed or portable communication device such as a desktop or laptop computer, a handheld, wireless communication device or a mobile robotic device. In this case, the minimum required configuration for a client communication device is that it is able to support various types of communication session, that it is able to support the publish/subscribe messaging model, as described in the IETF RFC 3920 and RFC 3921 otherwise known at the extensible messaging and presence protocol (XMPP), and it includes functionality that enables them to request and receive update software over the network. The number of client communication devices connected to the network is not necessarily limited and can reasonably be in the thousands or tens of thousands of devices that are distributed over a wide or small geographic region.

The gateway 12 in FIG. 1, among other things, is the signal interface between the WAN 10 and the LAN 11 and operates to receive messages and information generated by the client communication devices 0-N and to send the messages and/or information to the logical server 13. It also operates to receive information and messages from the logical server 13 and send them to any or all of the client communication devices 0-N. Logical server 13 can represent multiple servers in a server farm configuration, but is seen by the client devices 0-N over the WAN 10 as the single logical server 13. Logical server 13 includes functionality that generally allows it to support the establishment, maintenance and termination of communication sessions. The server 13 is also implements XMPP as defined in RFC 3920 and 3921. Both RFC 3920 and 3921 are publically available documents and well know to those familiar with pub/sub technology. The logical server 13, according to one embodiment of the invention, serves to maintain at least one subscriber update queue. The logical server 13 is connected to a data base 14 that can store update software files for distribution to the clients 0-N. Finally, the administrative server 16 is connected to both the data base 14 and to the logical server 13 and generally operates to control the client software update process to assign client communication devices to particular subscriber update queues included in the logical server 13 according to a set of predefined rules and it generally supports a process for updating software files in each of the client communication devices.

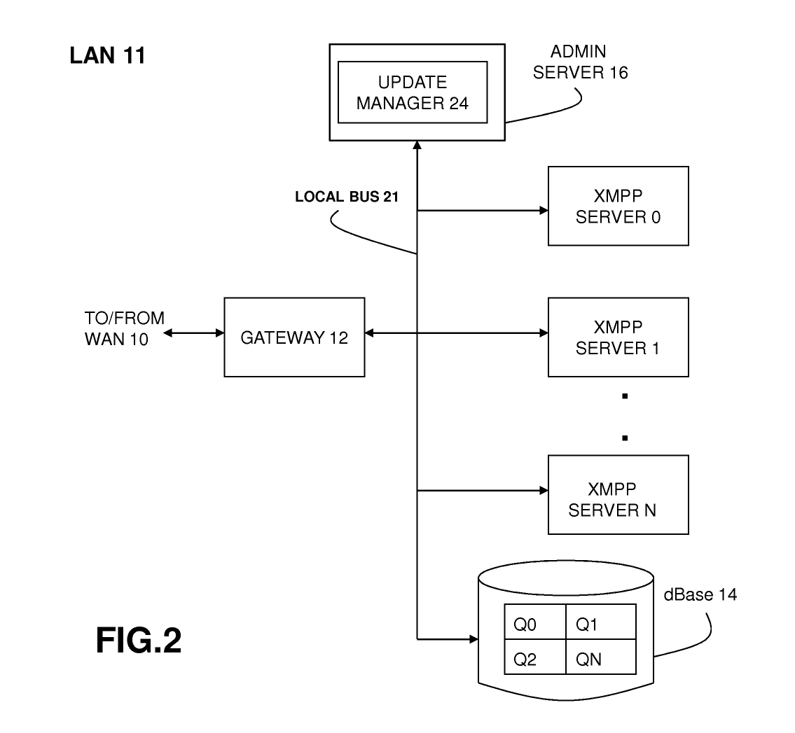

FIG. 2 is a more detailed drawing of the LAN 11 of FIG. 1 showing the network elements employed to implement the preferred embodiment of the invention. The gateway 12 of FIG. 1 is connected to the WAN 11 and is in communication over a local bus 21 with a plurality of XMPP servers 0-N, the data base 14 and the administrative server 16. Each of the XMPP servers 0-N are in communication with the dbase 14 of FIG. 1 over the local bus 21 and the admin server 16 that includes a software update manager module 24. As described previously with reference to FIG. 1, the gateway 12 serves as the interface between LAN 11 and WAN 10, it receives messages and information from any of the client devices 0-N of FIG. 1 and forwards these messages and information to any one of the XMPP servers 0-N according to a server network address included in the message. The XMPP servers 0-N comprise the logical server 13 of FIG. 1 which can be seen by each client device as a single, logical network device. Each of the XMPP servers 0-N that comprise the logical server 13 operate to support, among other things, the pub/sub messaging model, the distribution of update software to client devices and to generally support communication sessions between the client communication devices. The software update manager module 24 can be controlled by a network administrator to load update software files onto a plurality of data base 14 update software queues 0-N (where “N” in an integer) where they can be accessed by the XMPP servers 0-N for distribution to any of the client devices 0-N connected to the WAN 10 of FIG. 1. Each date base 14 software update queue 0-N can store the same software update file images. In other words, data base 14 software update queue 0 can include one update software file, and each of the other data base 14 subscription queues 1 to N can also contain a mirror image of the same software update file.

Continuing to refer to FIG. 2, the gateway 12, XMPP servers 0-N, the update manager module 24 and the data base 14 collectively operate to provide each of the client devices 0-N of FIG. 1 with a software update service. At some point in time after being purchased, a client communication device, client device 1 of FIG. 1 for instance, can register or subscribe to the software update services that are supported by the logical server 13. More specifically, during this initial registration session the update manager module 24 in the administrative server 16 can assign client communication device 1 to a particular subscriber update queue located on one of the XMPP servers 0-N, according to a predefined set of assignment rules. These assignment rules are designed to assign the client communication devices to a subscriber update queue located on a particular XMPP server 0-N such that the software update process is substantially evenly distributed among each of the XMPP servers 0-N. This predefined set of assignment rules can be instructions to assign client communication devices to the subscriber update queues according to a statistical round-robin scheme, to assign client communication devices according to the time of day that the client device is turned on, or according to some other statistical parameter. Regardless of the particular rules employed, the assignment of client devices to the subscriber update queues according to these rules results in the client communication device software update process being distributed substantially evenly over the XMPP servers 0-N.

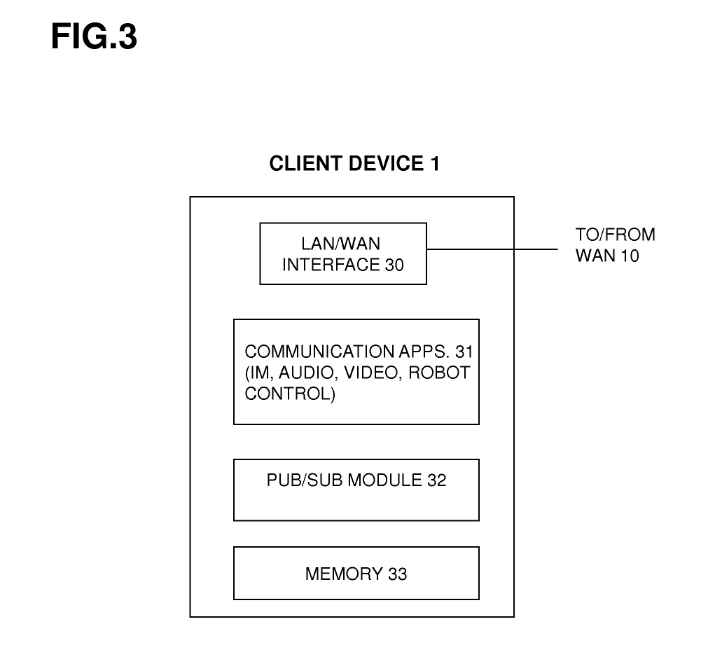

FIG. 3 is a block diagram showing functionality that can be included in any one of the client communication devices, 0-N, of FIG. 1 to support the software update process of the invention and to support the initiation and maintenance of several different types of communication sessions. The client device 1 can include a WAN interface module 30, a communication applications module 31 and a presence agent module 32. The WAN interface module 30 includes functionality that operates to send and receive packets of information to and from the WAN 10. The packets of information can include voice or video information, control information directed to a mobile robotic device and requests for updated versions of software. The communication application module 31 can include an audio and/or video communications application and a mobile robotic device control application. The pub/sub module 32 includes functionality that operates to generate software update requests for transmission to any one of the XMPP servers and to receive updated software files from any one of the XMPP servers for storage in a communication device memory 33. As previously described with reference to FIG. 1, the client device 1 can be a desktop or laptop computer or any one of a variety of wireless communication devices capable of connecting to the WAN 10. In operation, the client device 1 can be used to conduct audio and/or video sessions or instance messaging sessions with friends, and it can also be used to control the operation of a mobile robotic device that is either local or remote with respect to the location of the client device N.

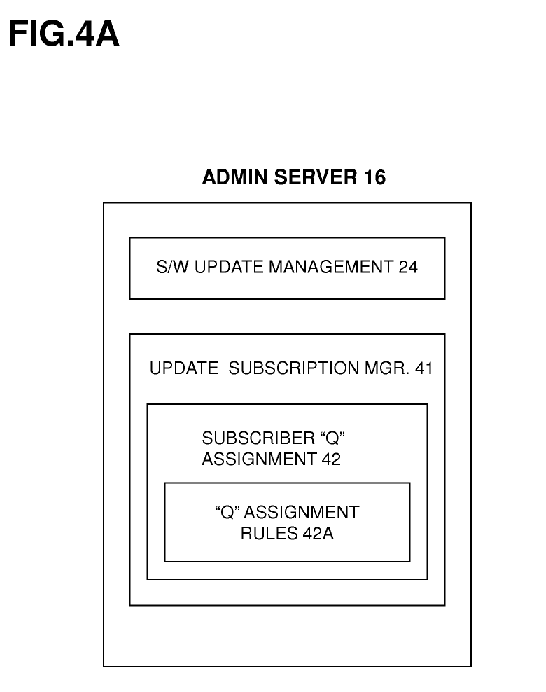

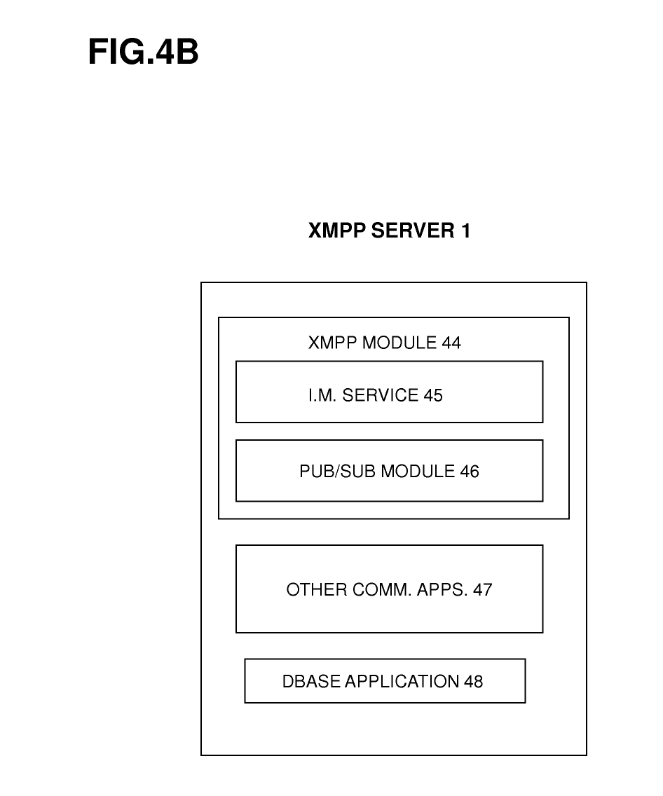

FIG. 4A is a block diagram illustrating functionality that can be included in the administrative server 16 of FIG. 2. The admin server 16 generally includes a software update management module 24 and a software update subscription module 41. The software update management module 24 generally controls the process of updating software files that can be included in each of the client communication devices as described earlier with reference to FIG. 2. The software update subscription module 41 includes subscriber queue assignment functionality 42 which operates to control the assignment of client devices to a particular subscriber queue maintained, according to pre-determined queue assignment rules 42A, in a particular XMPP server, such as XMPP server 1 for instance. As described earlier with reference to FIG. 2, this queue assignment typically occurs once during the initial client device service registration process.

Turning now to a description of FIG. 4B, which is a block diagram of the functionality included in any one of the XMPP servers 0-N briefly described earlier with reference to FIG. 2. The XMPP server, which can be the XMPP server 1 in FIG. 2 in this case, includes an XMPP module 44 that implements functionality to support an IM service 45 and pub/sub functionality 46. A module 47 includes functionality to support one or more other types of communication sessions such as audio, video or texting. More specifically with respect to the pub/sub module 46, the XMPP server 1, as described previously, under the general control of the software update management module 24 described in FIG. 4A, supports the pub/sub messaging model wherein a client device subscribes to a service supported by the XMPP server and the XMPP server publishes information to the client subscriber devices in a “push” operation. Such pub/sub functionality and operation is well know to those familiar with technology described in RFC 3921 and 3922 and so will not be described here in detail. XMPP server 1 also includes a data base application module 48 that generally operates to manage transactions between the server 1 and the data base 14, such as retrieving software update files for publication to the client subscriber devices.

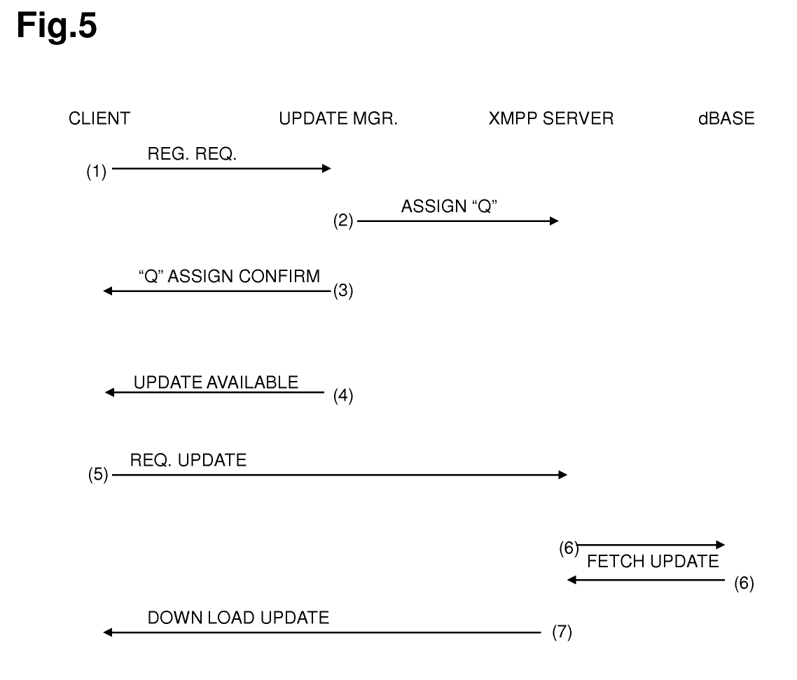

FIG. 5 is a diagram illustrating the signaling protocol employed between the client communication devices 0-N, the XMPP servers 0-N, the update manager 24 and the data base 14 to perform a client communication device software update process that is substantially balanced among the XMPP servers 0-N. This diagram shows a client, which can be any of the client communication devices 0-N, it shows a server, which can be any of the XMPP servers 0-N, is shows a data base, which in this case is the data base 14 of FIG. 2, and it shows an update manager which in this case is the manager 24. Starting at the top of FIG. 5, and assuming that the update manager 24 has installed an updated version of a software file into each of the database 14 queues 0-N, one of the client communication devices 0-N is turned on and generates a device registration request message (1) that is sent to the update manager 24. The update manager 24 in turn (2) assigns the client communication device to a subscriber update queue associated with one of the XMPP servers 0-N according to a set of pre-defined rules. The update manager 24 then (3) sends a message to the client device that requested to be registered with the update service that includes “Q” assignment confirmation information. The update manager 24 periodically sends a message (4) to the client communication device indicating that a new/updated software version is available. In response, the client device (5) sends a message to the XMPP server requesting to receive the updated software version and the XMPP server responds by (6) fetching the updated software version from a update software queue in the data base 14 and (7) down loads the software file(s) to the requesting client device.

The software update protocol described with reference to FIG. 5 is a distributed process that can run on some or all of the XMPP servers 0-N in parallel. This software update protocol extends the current Extensible Messaging and Presence Protocol (XMPP) and enables an XMPP capable server to support the automatic updating of software running on client communication devices that are subscribed to the software update service in a manner that substantially balances the software update process among a plurality of XMPP servers. The distribution/balancing of this software down-loading process not only mitigates the XMPP server over-loading problem, but it also lowers overall network bandwidth consumption and therefore the cost associated with purchasing network bandwidth.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. Method for updating software included in a pub/sub capable communication device, comprising:
the pub/sub capable communication device sending a message to a software update manager requesting to subscribe to an update software service;
the software update manager receiving the subscription request message, assigning the pub/sub capable communication device to a subscription queue associated with one of a plurality of XMPP servers according the a predefined set of rules and sending a message to the pub/sub capable communication device indicating that an updated software file is available;
the pub/sub capable communication device receiving the message indicating the updated software is available and sending a message to the XMPP server requesting the updated software file; and
the XMPP server receiving the message with the request for the updated software file from the pub/sub capable communication device, fetching the updated software file from the subscription queue with which it is associated, and sending the update software file to the requesting pub/sub capable communication device.

2. The method of claim 1 wherein the communication device is a robotic device.

3. The method of claim 1 wherein the pub/sub capable communication device is connected to a wide area network.

4. The method of claim 1 wherein the software update manager, the XMPP servers and the database are all connected to the same local area network.

5. The method of claim 1 wherein one or more of the software update manager, the XMPP servers and the database are connected to different local area networks.

6. The method of claim 1 wherein the message is an instant message.

7. The method of claim 1 wherein the software update files are stored in an assigned subscriber update queue.

8. The method of claim 1 wherein the predefined set of rules are instructions to assign client communications devices to a subscriber update queue according to one or a statistical round-robin scheme and the time of day that the client device is turned on.
